(19) United States
(12) Patent Application Publication
(10) Pub. No.: US 2023/0397631 A1
(43) Pub. Date: Dec. 14, 2023

(54) METHOD FOR EXTRACTING COFFEE USING SUPERCRITICAL NANOBUBBLES, AND COFFEE EXTRACTED THEREBY

(71) Applicant: Shang Wha CHA, Jeollanam-do (KR)

(72) Inventors: Shang Wha Cha, Jeollanam-do (KR); Su Min Kim, Gwangju (KR); Su Hyun cha, Jeollanam-do (KR)

(21) Appl. No.: 18/021,823

(22) PCT Filed: Aug. 20, 2021
(86) PCT No.: PCT/KR2021/011102

§ 371 Date: Feb. 17, 2023

(30) Foreign Application Priority Data
Aug. 20, 2020 (KR) 10-2020-0104905

(51) Int. Cl. A23F 5/24; B01F 23/30; B01F 23/2373; B01F 23/237

(52) U.S. Cl. CPC A23F 5/243; B01F 23/2376; B01F 23/2373; B01F 23/341

(57) ABSTRACT

The present invention relates to a method for extracting coffee using supercritical nanobubbles, and coffee extracted thereby, and specifically, to a method for extracting coffee capable of extracting coffee by bringing nanobubbles having a high pressure corresponding to a supercritical state into contact with coffee beans, thereby improving an extraction speed of coffee and increasing a concentration of the coffee, and coffee extracted thereby. A method for extracting coffee using supercritical nanobubbles of the present invention includes a bubble water generation step of obtaining bubble water in which nano bubbles are formed, and an extraction step of extracting liquid coffee by applying bubble water to ground coffee beans, in which the bubbles have a diameter of 10 to 200 nm and an internal pressure of 50 to 150 atm.

### TECHNICAL FIELD

The present invention relates to a method for extracting coffee using supercritical nanobubbles, and coffee extracted thereby, and specifically, to a method for extracting coffee capable of extracting coffee by bringing nanobubbles having a high pressure corresponding to a supercritical state into contact with coffee beans, thereby improving an extraction speed of coffee and increasing a concentration of the coffee, and coffee extracted thereby.

### BACKGROUND ART

In general, coffee is a beverage extracted from ground coffee beans and is positioned as one of the world's representative favorite foods.

The taste and aroma of coffee extracted from coffee beans may vary depending on various factors. Depending on varieties of coffee tree as the basic raw material, the taste and aroma may vary. In addition, the taste and aroma of coffee may be sensitively changed also in the processing process of coffee, such as a quality of green beans, a degree of roasting, and an extraction method.

Coffee has as many different extraction methods as its long history, and each coffee has its own unique taste and aroma according to each extraction method. Types of coffee according to the representatively known extraction method are as follows.

First, there is espresso coffee, which has recently been widely known through coffee chain stores and the like. It is a method of extracting coffee in a short time at high temperature and high pressure by using an espresso machine. Usually, high-temperature water of 90 degrees or higher and high pressure of 8 to 10 bars are used, and very strong coffee is extracted, as compared with other extraction methods, so that it is possible to feel the taste and aroma of strong coffee. However, since high temperature and high pressure are required, an expensive espresso machine configured by a porta filter, a hot water boiler, a high pressure pump and the like is essential. In addition, since coffee is extracted in a high-temperature environment, after extraction, the flavor is deteriorated in a short time due to oxidation or deterioration of ingredients included in coffee itself or volatilization of volatile ingredients.

Drip coffee is coffee that is extracted by putting ground coffee powders into a kind of funnel called a dripper and slowly passing hot water through the coffee powders. Drip coffee is a method that can be easily used at home without relatively expensive equipment, and is also called hand drip, and a semi-automated device is widely distributed under the name of a coffee maker. However, since the extraction time is long and only a small amount of coffee can be extracted, it is not suitable for mass production or industrial use.

Meanwhile, as an extraction method using cold water instead of hot water, there is cold brew coffee. In Korea, it is more widely known as ‘Dutch coffee’. This method uses cold water to extract coffee liquid over a long period of time. Cold brew coffee has an advantage in that a caffeine content is small compared to the capacity and the taste and aroma of coffee can be extracted as they are because cold water at room temperature is used instead of hot water. Therefore, cold brew coffee is preferred by many coffee lovers as one of extraction methods by which it is possible to enjoy the taste and aroma of coffee as they are. However, since cold brew coffee is extracted over a long time using cold water, a lot of time is required for extraction.

Recently, as one of differentiated extraction methods, as disclosed in Korean Patent Application Publication No. 10-2011-0019974, a technology using supercritical fluid extraction equipment has been attempted for coffee extraction.

According to a method based on supercritical fluid extraction (SFE) technology, it is possible to continuously change the density from a rarefied state close to an ideal gas to a high-density state close to a liquid density by controlling temperature and pressure under supercritical conditions. Therefore, it is possible to extract the desired coffee material by adjusting the solubility, viscosity, diffusion coefficient, thermal conductivity and molecular state of the fluid with simple condition change. Also, it is possible to change the extraction efficiency by adjusting the extraction time. In addition, the high-quality aroma ingredients present in coffee are increased. In this way, the coffee extraction using a supercritical fluid has an advantage in that it is possible to feel a deeper taste by more extracting the original aroma of coffee than a general coffee extraction method. The extraction method using the supercritical fluid extraction equipment has the advantage of increasing the high-quality aroma ingredients, but also has following disadvantages.

First, complex and expensive equipment is required and expert control is required. Coffee is a popular favorite food, and therefore, it is required that anyone should be able to extract it easily. However, the supercritical fluid extraction method is difficult for ordinary people to operate, and even experimental equipment is too expensive, so that the equipment is not suitable for ordinary people to use.

Second, according to the supercritical fluid extraction method, a certain temperature and a pressure that exceeds a critical point are used for an extraction container. Therefore, as the fluid comes out of the extraction container, the shape is destroyed, and the dissolved extract destroys the cell wall by the pressure and is pushed out, resulting in a large number of air contact surfaces. As a result, oxidation occurs rapidly, making it difficult to store the extract for a long time.

### DETAILED DESCRIPTION OF THE INVENTION

### Technical Problem

The present invention has been made to solve the above problems, and an object thereof is to provide coffee having characteristics equivalent to coffee extracted with supercritical fluid extraction equipment by using high-pressure nanobubbles to extract coffee, instead of using complicated and expensive supercritical fluid extraction equipment.

Accordingly, in the present invention, physical properties of nanobubbles are studied to measure an extraction speed of coffee, and the like, depending on a pressure inside nanobubbles and a type of gas constituting the nanobubbles, and an extraction concentration and a sugar content of coffee are examined Thereby, it is intended to confirm whether the present invention can replace the extraction method using the supercritical fluid extraction equipment by comparison with the method using the conventional supercritical fluid extraction equipment.

### Technical Solution

A method for extracting coffee using supercritical nanobubbles of the present invention for achieving the above object includes a bubble water generation step of obtaining bubble water in which nanobubbles are formed; and an extraction step of extracting liquid coffee by applying the bubble water to ground coffee beans, in which the nanobubbles have a diameter of 10 to 200 nm and an internal pressure of 50 to 150 atm.

The nanobubbles in the bubble water generation step are formed of any one single-component gas of hydrogen, oxygen, and carbon dioxide.

In the bubble water generation step, a bubble concentration of the bubble water is 1.0×10⁶ to 9.0×10¹²/ml.

In the extraction step, the coffee is extracted with the bubble water being adjusted to 10 to 100° C.

Coffee extracted by the supercritical nanobubbles of the present invention for achieving the above object is extracted by any one of the methods described above.

### Advantageous Effects of Invention

The present invention presents correlation between a size and an internal pressure of bubbles, and accordingly, experimentally demonstrates that nanobubbles have a high pressure corresponding to a supercritical state similar to supercritical fluid extraction conditions.

The present invention can improve the extraction speed of coffee and increase the concentration of coffee by extracting coffee using high-pressure nanobubbles corresponding to the supercritical state.

The present invention can provide an extraction method with characteristics equivalent to those of supercritical fluid extraction equipment at low cost without change in shape or destruction of tissue by using nanobubbles not only for coffee but also for beverages such as tea that is extracted with water.

### BRIEF DESCRIPTION OF DRAWINGS

FIG. 1 is a schematic diagram for showing behaviors of microbubbles and nanobubbles in water.

FIG. 2 is a configuration view schematically showing an example of a bubble water generator that is used in a coffee extraction method according to an embodiment of the present invention;

FIG. 3 is a schematic diagram showing a coffee extraction process by hydrogen nanobubble water.

FIG. 4 is a graph showing a correlation between a diameter of nanobubbles and a pressure of nanobubbles.

FIG. 5 is an image showing an appearance of nanobubbles in oxygen nanobubble water.

### BEST MODE FOR IMPLEMENTATION OF THE INVENTION

Hereinafter, a method for extracting coffee using nanobubbles according to a preferred embodiment of the present invention and coffee extracted thereby will be described in detail.

A method for extracting coffee using nanobubbles according to an embodiment of the present invention includes a bubble water generation step of obtaining bubble water in which nanobubbles are formed, and an extraction step of extracting liquid coffee by applying the bubble water to ground coffee beans. Each step will be specifically described.

1. Bubble Water Generation Step

First, gas is injected into a liquid to obtain bubble water in which nanobubbles are formed.

The bubble water means a liquid in which nanobubbles are formed. In the present invention, nanobubbles mean that an average diameter of bubbles is a nanometer order size. For example, the average diameter of the nanobubbles may be 10 to 200 nm.

Nanobubbles have a negative surface charge and a characteristic of rotating in liquid due to a wavelength. The negative charge of each nanobubble repels each other and prevents many nanobubbles from combining with each other even in a dense state. It is known that, when the bubbles are reduced to a nanometer order size, an amount of hydroxyl radicals (OH⁻) at the interface relatively increases, and therefore, the bubbles are negatively charged, undergo self-pressurization and remain in water for about 6 months or longer. The nanobubbles are known to have a strong internal pressure, and therefore, do not burst well even at high temperatures. It is known that the excellent stability of the nanobubbles results from suppression of collision and fusion between bubbles due to the negatively charged surface (initial zeta potential: −24.01 to 30.51 mV), and the nanobubbles once generated do not easily disappear even when heated (Seunghun Oh, Research on the Generation and Application of Nanobubbles, 2017).

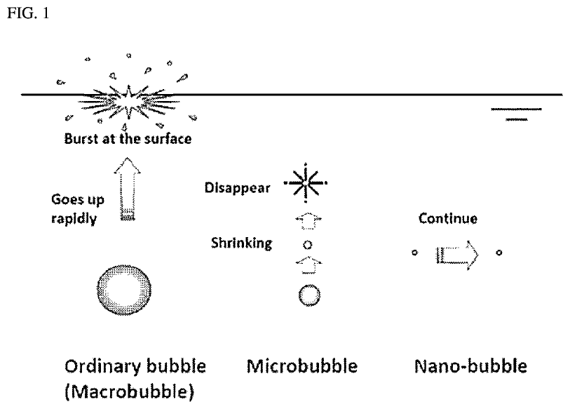

After generation, a change aspect of bubbles is different, depending on sizes thereof. As shown in FIG. 1, microbubbles with a diameter of 1 to 100 μm gradually decrease in size as they rise to the surface of the water, and then burst and disappear in water or on the surface of the water, while nanobubbles exist in water for a long time and then contract and disappear without bursting. At the interface of the nanobubbles, there is a very strong hydrogen bond that can be found in ice, which eventually serves to keep the gas from escaping despite the strong internal pressure of the nanobubbles.

A supercritical nanobubble refers to a nanobubble having a high internal pressure corresponding to a supercritical state. For example, the internal pressure of the nanobubbles may be 50 to 150 atm. The size is ultra-fine at the level of nanometers, and the nanobubbles with high pressure corresponding to the supercritical state are smaller than pores of roasted coffee beans. Therefore, when extracting coffee, the nanobubbles infiltrate into a tissue of the coffee beans, thereby increasing the coffee extraction efficiency.

When the number of bubbles contained per 1 ml of bubble water is referred to as a bubble concentration (particles/mi), the bubble concentration of the bubble water used in the present invention may be 1.0×10⁶ to 9.0×10¹².

The conventional methods for forming bubbles in a liquid are largely divided into two types.

First, there is a method of generating bubbles by applying mechanical vibration to a liquid using ultrasonic waves or the like. This method can easily control an amount of bubbles to be generated, but cannot control the size of bubbles.

Second, there is a method of generating bubbles by controlling flow of a fluid. This method has an advantage in that the amount and size of bubbles can be easily controlled. However, since the generated bubbles are large bubble particles having a micrometer size of about 50 to 100 μm in diameter, the bubbles have a short residence time in water and a small gas-liquid contact area, so the effect is poor.

Accordingly, the present invention uses bubble water made using the fine bubble generator disclosed in Korean Patent No. 10-1863769, which is a registered patent of the present applicant. The fine bubble generator can control the size of fine bubbles to the nanometer order size, and at the same time, the generated fine bubbles can stably exist in a liquid for a long time of 5 months or more.

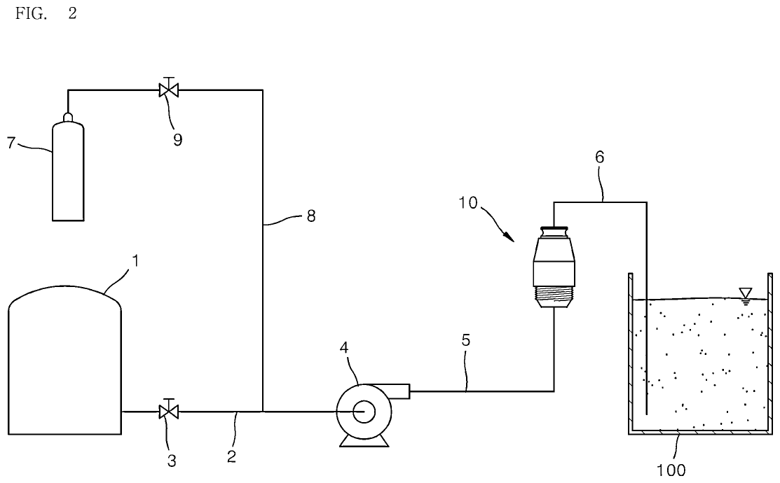

An example of a bubble water generator using the fine bubble generator is shown in FIG. 2.

Referring to FIG. 2, the bubble water generator includes a liquid storage tank 1 in which liquid is stored, a pump 4 connected to the liquid storage tank 1 by a liquid supply line 2, a connection line 5 connecting a discharge port of the pump 4 and a fine bubble generator 10, a bubble water discharge line 6 connected to the fine bubble generator 10 and discharging bubble water, a bubble water storage tank 100 connected to the bubble water discharge line 6 and configured to store therein bubble water, a gas bombe 7 in which gas is stored, and a gas injection line 8 connecting the gas bombe 7 and the liquid supply line 2.

Drinking water may be used as the liquid stored in the liquid storage tank 1. For example, groundwater or tap water may be used as drinking water.

The liquid stored in the liquid storage tank 1 flows into the pump 4 through the liquid supply line 2. A valve 3 capable of opening and closing a flow path is installed on the liquid supply line 2.

Gas to be injected into the liquid is stored in the gas bombe 7. The gas stored in the gas bombe 7 is injected into the liquid supply line 2 through the gas injection line 8. A valve 9 capable of opening and closing a flow path is installed on the gas injection line 8.

When gas is injected into the liquid supply line 2 through the gas injection line 8, the gas is mixed with the liquid flowing along the liquid supply line 2. The liquid mixed with the gas passes through an impeller of the pump 4 rotating at high speed, and at this time, the gas is broken into a small bubble form.

The liquid discharged through the discharge port of the pump 4 flows into the fine bubble generator 10 through the connection line 5. While the liquid passes through the fine bubble generator 10, fine nanobubbles are formed in the liquid. The bubble water in which nanobubbles are formed is discharged through the bubble water discharge line 6 and stored in the bubble water storage tank 100. The bubble water stored in the bubble water storage tank 100 is used for coffee extraction.

Hydrogen, oxygen, carbon dioxide, air, etc. may be used as the gas stored in the gas bombe 7, which is to be injected into the liquid for forming nanobubbles. When hydrogen is used as the gas, the nanobubbles are formed of hydrogen gas.

When oxygen is used as the gas, the nanobubbles are formed of oxygen gas. When carbon dioxide is used as the gas, the nanobubbles are formed of carbon dioxide gas. When air is used as the gas, the nanobubbles are formed of air.

Preferably, as a gas that is injected into the liquid so as to form nanobubbles, hydrogen, oxygen, and carbon dioxide composed of a single component are more suitable than air. More preferably, hydrogen or oxygen is suitable. In the case of single-component gases, the smaller the molecular weight is, the better the coffee extraction effect is. Therefore, hydrogen or oxygen, particularly hydrogen is preferable as a gas for forming nanobubbles.

2. Extraction Step

Next, bubble water is applied to coffee beans to extract liquid coffee. Coffee beans are roasted green beans, and may be used ground to a particle size of about 10 to 100 mesh. Roasted coffee beans form a dry porous tissue in which countless small pores are formed by carbonization. The pores formed in coffee beans have a micrometer order size or larger. Therefore, when bubble water is applied to coffee beans, nanobubbles in bubble water can sufficiently enter the pores of coffee beans.

When the ground coffee beans are prepared, bubble water is applied to the coffee beans to extract coffee. The coffee may be extracted using a usual coffee extraction machine or extracted by a hand drip method.

Bubble water in a room temperature state may be used. Since coffee is extracted by nanobubbles, sufficient extraction effect can be obtained even when bubble water is used without being heated. However, if necessary, coffee may be extracted after heating the bubble water to a certain temperature or cooling the bubble water to a lower temperature. For example, bubble water may be used for extraction after being adjusted to 10 to 100° C.

When bubble water in which nanobubbles are formed is applied to coffee beans, the nanobubbles in the bubble water adhere to surfaces of the coffee beans or enter the pores of the coffee beans. The nanobubbles are maintained in a stable state in liquid, but the bubbles are destroyed while coming into contact with coffee beans, and at this time, a high pressure of 50 to 150 atm of the fine bubbles is applied to the coffee beans. The pressure of 50 to 150 atm corresponds to the supercritical pressure of the gas constituting the bubbles. Therefore, the present invention has the effect of supercritical fluid extraction without using expensive supercritical fluid extraction equipment.

In this way, since the supercritical pressure is applied by the nanobubbles during coffee extraction, the extraction speed can be improved and the concentration of coffee can be increased.

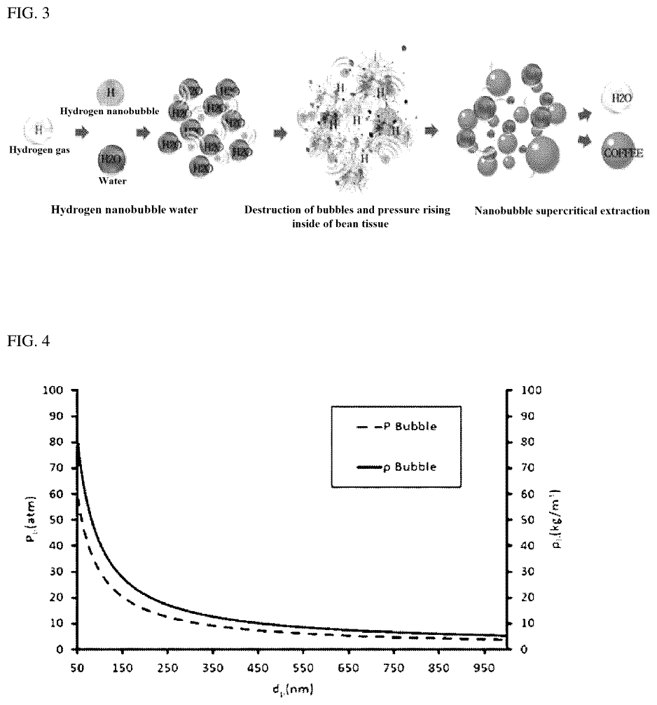

FIG. 3 schematically shows a process of coffee extraction by hydrogen nanobubble water generated by injecting hydrogen gas. Referring to FIG. 3, hydrogen nanobubbles infiltrate into the coffee bean tissue and are destroyed inside the tissue, and accordingly, the pressure of the nanobubbles is applied to the coffee beans, so that coffee is extracted under supercritical conditions.

Below, the present invention will be described through examples. However, it will be understood that the following examples are intended to specifically describe the present invention and the scope of the present invention is not limited to the following examples.

<Size and Pressure of Nanobubbles>

The theoretical internal pressure inside the nanobubbles was calculated using the Young-Laplace equation and the ideal gas equation. This is intended to verify whether is the nanobubbles have force (pressure for supercritical extraction) to push out the ingredients inside the coffee.

Using the Young-Laplace equation and the ideal gas equation, the bubble pressure according to the bubble diameter has the following correlation.

$${p}_{b} = \frac{( {P}_{1} + 4 σ / {d}_{p} ) M {W}_{gas}}{R T}$$

(MW_{gas}: mole mass of gas (g/mol), R: ideal gas constant (8.3144 J/mol/K), T: absolute temperature (K), Pb: bubble internal pressure (N/m²), P₁: pressure of water outside bubble (N/m²), δ: surface tension (N/m), d_{P}: bubble diameter (m))

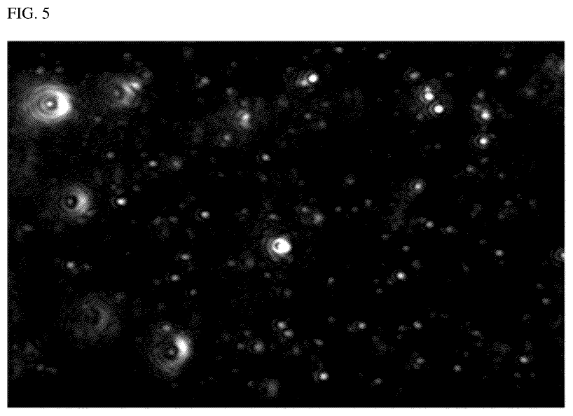

From the above equation, it can be seen that the diameter of the bubble and the pressure of the bubble are inversely proportional to each other. That is, the smaller the bubble size is, the higher the bubble pressure is. When the pressure of water is 1 atm and oxygen is used as a gas, the bubble diameter and bubble pressure are graphed as shown in FIG. 4. In FIG. 4, the dotted line graph indicates the pressure within the bubble, and the solid line graph indicates the density within the bubble.

As shown in FIG. 4, it can be seen that the pressure inside the bubble rapidly increases at the diameters of 170 nm or smaller.

<Manufacturing of Nanobubble Water>

Hydrogen nanobubble water, oxygen nanobubble water, and carbon dioxide nanobubble water were each manufactured using the bubble water generator shown in FIG. 2. With the above calculation formula, nanobubbles with a size close to a pressure of 100 atm were generated. As a result of measuring the number and size distribution of bubbles using a nanobubble measuring device, the diameter distribution of bubbles was 48 to 103 nm with an average diameter of 88 nm, and the bubble concentration was 19.9×10⁸ per 1 ml of bubble water.

An appearance of nanobubbles present in oxygen nanobubble water is shown in FIG. 5, as an example.

<Coffee Extraction>

1. Material Preparation

For coffee beans, Colombia beans (Arabica variety) of Excelso (6-40) ep/Very Clean grade harvested and processed in September 2019 were used. For roasting, the coffee beans were put into a semi-hot air roaster (THCR-01, Taehwan Automation Industry, Korea) at 220° C., and roasted under conditions of 1st crack 190° C./PEAK 197° C./OUT 207° C., and the color (Agtron) of the beans after roasting was 60.

After roasting, the beans were stored frozen to prevent oxidation. The coffee beans were ground with a grinding degree of 9.5 using the EK-43 model, and g of coffee beans were used for coffee extraction.

2. Extraction Experiment The sugar content (Brix) and concentration (TDS; Total Dissolved Solid) of the extracted coffee were compared. As the TDS measuring device, RCM-1000BT available from HM DIGITAL was used, and as the saccharimeter, SCM-1000 available from HM DIGITAL was used. The color (Agtron) of the beans was measured using TRA-3000 available from ROAMI.

The extraction experiment was divided into first and second rounds. The first extraction experiment was conducted by changing the beans used for extraction. That is, drip extraction was performed by pouring purified water into beans to which supercritical fluid was applied using the supercritical fluid extraction equipment and beans to which supercritical fluid was not applied, respectively.

The second extraction experiment was conducted by changing the water used for extraction. That is, drip extraction was performed using nanobubble water and purified water.

(1) First Extraction Experiment

The supercritical fluid was applied to the beans by using the supercritical fluid extraction equipment (SCFE-P400, Ilshin Autoclave, Korea) to supercritically process the beans. Carbon dioxide was used as the supercritical fluid and the processing was performed at a temperature of 50° C. and a pressure of 100 to 400 bars.

The beans supercritically processed and the beans not supercritically processed were drip-extracted using water, respectively. For water, purified water heated to 50° C. was used. Kalita was used as a dripper, and extraction was performed by pouring 120 ml of water at a time without giving a separate soaking time or pouring water separately. The first extraction experiment results are shown in Table 1 below.

Sample W-50 was coffee extracted by the drip extraction method in which purified water was applied to beans that have not been supercritically processed, SFE-100 was coffee extracted by the drip extraction method in which purified water was applied to beans processed under supercritical condition of 100 bars, SFE-200 was coffee extracted by the drip extraction method in which purified water was applied to beans processed under supercritical condition of 200 bars, SFE-300 was coffee extracted by the drip extraction method in which purified water was applied to beans processed under supercritical condition of 300 bars, and SFE-400 was coffee extracted by the drip extraction method in which purified water was applied to beans processed under supercritical condition of 400 bars, In Table 1 below, Agtron is a value representing the color of coffee beans before extraction.

TABLE 1

| | | | | Sugar | Concen- |
|---|---|---|---|---|---|
| | Pressure | Temperature | | content | tration |
| Sample | (bar) | (° C.) | Agtron | (Brix)% | (TDS)% |
| W-50 | atmospheric | 50 | 60.0 | 1.4 | 0.81 |
| | pressure | | | | |
| SFE-100 | 100 | 50 | 61.5 | 1.8 | 1.38 |
| SFE-200 | 200 | 50 | 65.3 | 1.3 | 0.60 |
| SFE-300 | 300 | 50 | 65.9 | 1.5 | 0.49 |
| SFE-400 | 400 | 50 | 60.4 | 0.9 | 0.85 |

Referring to the results of Table 1, the sugar content of W-50 was 1.4 and the concentration was 0.81. This is a result that falls far short of the TDS of 1.15-1.35%, which is the ideal extraction concentration presented by the Specialty Coffee Association of America (SCAA). The coffee extracted by applying the supercritical fluid to the beans showed the higher sugar content and concentration than those of the coffee extracted without applying the supercritical fluid. When the supercritical fluid was applied to the coffee beans, the higher the pressure of the supercritical fluid was, the lower the sugar content and the concentration were. Among the coffees extracted by applying the supercritical fluid to the beans, SFE-100 was found to be closest to the TDS of 1.15-1.35%, which is the ideal extraction concentration presented by the Specialty Coffee Association of America (SCAA).

After applying the supercritical fluid, when the pressure was lowered to the atmospheric condition, it was observed that the coffee beans exploded and broke into several pieces inside the tank. Samples SFE-100, SFE-200, SFE-300, and SFE-400 all showed stains on the beans, and in SFE-300 and SFE-400, it was confirmed with naked eyes that oil was extracted, and there was a strong oil scent.

In the case of the beans processed under supercritical conditions, the color (Agtron) value was changed. This seems to result from the extraction and movement of the ingredients of the beans when applying the high pressure under critical conditions by applying the supercritical fluid to the beans.

(2) Second Extraction Experiment

Drip extraction was performed using purified water and nanobubble water, as water, respectively. Water was used heated to 98° C., Kalita was used as a dripper, and extraction was performed by pouring 120 ml of water at a time without giving a separate soaking time or pouring water separately.

As the nanobubble water, hydrogen nanobubble water, oxygen nanobubble water, and carbon dioxide nanobubble water were each used for extraction.

In the second extraction experiment, an extraction time was also measured, in addition to the sugar content (Brix) and concentration (TDS) of the coffee. The results are shown in Table 2 below.

Sample W-98 was coffee extracted by the drip extraction method in which purified water was applied to coffee beans, NB-H₂ was coffee extracted by the drip extraction method in which hydrogen nanobubble water was applied to coffee beans, and NB-O₂ was coffee extracted by the drip extraction method in which oxygen nanobubble water was applied to coffee beans, and NB-CO₂ was coffee extracted by the drip extraction method in which carbon dioxide nanobubble water was applied to coffee beans.

TABLE 2

| | | | Sugar | |
|---|---|---|---|---|
| | Temperature | extraction | content | Concentration |
| Sample | (° C.) | time | (Brix)% | (TDS)% |
| W-98 | 98 | 28 seconds | 1.2 | 1.06 |
| NB-H₂ | 98 | 22 seconds | 1.8 | 1.36 |
| NB-O₂ | 98 | 25 seconds | 1.6 | 1.25 |
| NB-CO₂ | 98 | 24 seconds | 1.5 | 1.19 |

Referring to the results of Table 2, the coffee drip-extracted with water at 98° C. showed the sugar content of 1.2 and the concentration of 1.06. The extraction time was 28 seconds. On the other hand, the coffee drip-extracted with nanobubble water showed the higher sugar content and concentration than those of the coffee drip-extracted with water, and the extraction time was shorter. In the case of drip extraction using the nanobubble water, the sugar content and the concentration were different depending on the type of gas used. The lower the molecular weight was, the higher the sugar content and the concentration were. Therefore, hydrogen, oxygen, or carbon dioxide may be used as a gas, but in terms of sugar content and concentration, it has been confirmed that hydrogen or oxygen, especially hydrogen, was the best.

In the case of drip extraction using the nanobubble water, the extraction time was shorter than the case of drip extraction using water, which is presumed to be the result of nanobubbles infiltrating into the coffee beans faster than water. The extraction time was found to be the shortest when hydrogen nanobubble water was used.

While the present invention has been described with reference to the embodiment, the embodiment is only exemplary, and one skilled in the art will understand that various modifications and equivalent embodiments can be made from the embodiment. Therefore, the protection scope of the present invention should be defined only by the appended claims.

1. A method for extracting coffee using supercritical nanobubbles, comprising:
generating bubble water by obtaining bubble water in which nanobubbles are formed; and
extracting liquid coffee by applying the bubble water to ground coffee beans, wherein the nanobubbles have a diameter of 10 to 200 nm and an internal pressure of 50 to 150 atm.

2. The method according to claim 1, wherein the nanobubbles in the generating of bubble water are formed of any one single-component gas of hydrogen, oxygen, and carbon dioxide.

3. The method according to claim 1, wherein in the generating of bubble water, a bubble concentration of the bubble water is 1.0×10⁶ to 9.0×10¹²/ml.

4. The method according to claim 1, wherein in the extracting, the coffee is extracted with the bubble water being adjusted to 10 to 100° C.

5. A coffee extracted using supercritical nanobubbles, wherein the coffee is extracted by the method according to claim 1.
